(19) United States
(12) Patent Application Publication
(10) Pub. No.: US 2015/0160036 A1
(43) Pub. Date: Jun. 11, 2015

(54) ELECTRONIC MAP DISTANCE MEASUREMENT METHOD AND DEVICE

(71) Applicant: TENCENT TECHNOLOGY (SHENZHEN) COMPANY LIMITED, Shenzhen, GD (CN)

(72) Inventor: Chang Liu, Shenzhen (CN)

(73) Assignee: TENCENT TECHNOLOGY (SHENZHEN) COMPANY LIMITED, Shenzhen (CN)

(21) Appl. No.: 14/404,930

(22) PCT Filed: May 29, 2013
(86) PCT No.: PCT/CN2013/076418

§ 371 Date: Dec. 1, 2014

(30) Foreign Application Priority Data
Jun. 1, 2012 (CN) 201210177903.8

(51) Int. Cl. G01C 21/36

(52) U.S. Cl. CPC G01C 21/3667

(57) ABSTRACT

Provided are an electronic map distance measurement method and device. The electronic map distance measurement method includes: setting a distance measurement start point and a distance measurement end point, and attaching the distance measurement start point and the distance measurement end point to an electronic map road network respectively (301); calculating a travel route between the distance measurement start point and the distance measurement end point and a distance of the travel route in the electronic map road network (302); and displaying the travel route and the distance of the travel route on the electronic map (303). The electronic map distance measurement method and device, by directly attaching to the electronic map to measure, an actual travel route and a distance thereof are provided so as to improve accuracy of route inquiry by a user, and any point on a travel route on the electronic map can be dragged, which is further convenient for the user to use.

### CROSS REFERENCE TO RELATED APPLICATIONS

The present application is related to and claims the benefit of Chinese Patent Application No. 201210177903.8, filed Jun. 1, 2012, entitled “Electronic Map Distance Measurement Method and Device”, the disclosure of which is incorporated herein in its entirety by reference.

### TECHNICAL FIELD

The present disclosure relates to electronic maps, and especially to an electronic map distance measurement method and device.

### BACKGROUND

An electronic map, i.e., a digital map, is a map which is stored and looked up digitally. In methods of storing information of electronic maps, generally, an electronic map is stored as a vector image, and may be enlarged, reduced, or rotated without affecting its display effect. It is very convenient for an electronic map to combine or join elements of the content of a general map to form a new map. The electronic map may be output in any scale and in any range. The electronic map is also very easy to be modified, which reduces the time of forming it into a drawing. The electronic map may also be combined conveniently with other information sources such as satellite videos, aviation images, etc., to form a new type of image.

Distance measurement is a common application of the electronic maps. During the distance measurement, a user first provides several points (e.g., a start point, a stay point, and an end point) on an electronic map, and then electronic map software will calculate a straight distance between any two points according a certain algorithm.

However, during the distance measurement in the traditional art, only straight distances between selected points on the electronic map are given, and an actual movement route cannot be provided. In addition, in the traditional art, stay point(s) between a start point and an end point cannot be modified directly on an electronic map, which may be inconvenient for a user to use.

### SUMMARY

An electronic map distance measurement method is provided according to embodiments of the present disclosure, so as to provide an actual movement route on an electronic map during distance measurement, which improves accuracy of route inquiry by a user.

An electronic map distance measurement device is provided according to embodiments of the present disclosure, so as to provide an actual movement route on an electronic map during distance measurement, which improves accuracy of route inquiry by a user.

Detailed solutions according to the embodiments of the present disclosure are as follows.

An electronic map distance measurement method is provided, including:

setting a distance measurement start point and a distance measurement end point, and attaching the distance measurement start point and the distance measurement end point to an electronic map road network respectively;

calculating a travel route between the distance measurement start point and the distance measurement end point and a distance of the travel route in the electronic map road network; and

displaying the travel route and the distance of the travel route on the electronic map.

An electronic map distance measurement device is provided, including a road network attachment unit, a route distance measurement calculation unit, and a display unit, in which:

the road network attachment unit is configured to set a distance measurement start point and a distance measurement end point, and attach the distance measurement start point and the distance measurement end point to an electronic map road network respectively; the route distance measurement calculation unit is configured to calculate a travel route between the distance measurement start point and the distance measurement end point and a distance of the travel route in the electronic map road network; and the display unit is configured to display the travel route and the distance of the travel route on the electronic map.

An electronic map distance measurement device is provided, including a memory and a processor which communicates with the processor. On the memory, a road network attachment instruction, a route distance measurement calculation instruction, and a display instruction executable by the processor are stored, in which

the road network attachment instruction is configured to instruct setting a distance measurement start point and a distance measurement end point, and attaching the distance measurement start point and the distance measurement end point to an electronic map road network respectively;

the route distance measurement calculation instruction is configured to instruct calculating a travel route between the distance measurement start point and the distance measurement end point and a distance of the travel route in the electronic map road network; and

the display instruction is configured to instruct displaying the travel route and the distance of the travel route on the electronic map.

As is seen from the foregoing solutions, in the embodiments of the present disclosure, first the distance measurement start point and the distance measurement end point are set, and the distance measurement start point and the distance measurement end point are attached to the electronic map road network; and then a travel route between the distance measurement start point and the distance measurement end point and a distance of the travel route are calculated in the electronic map road network, and then the travel route and the distance of the travel route are displayed on the electronic map. Thus, when the embodiments of the present disclosure are applied, by directly attaching to the electronic map to measure, an actual travel route and a distance are provided so as to improve accuracy of route inquiry by a user.

Further, in the embodiments of the present disclosure, a stay point on the travel route of the electronic map may be dragged directly, which is convenient for a user to use.

In addition, the embodiments of the present disclosure may provide various options of the travel mode, and the information may be prompted in various ways.

### BRIEF DESCRIPTION OF THE DRAWINGS

FIG. 1 is a first schematic diagram illustrating electronic map distance measurement in the traditional art;

FIG. 2 is a second schematic diagram illustrating electronic map distance measurement in the traditional art;

FIG. 3 is a schematic diagram illustrating a flowchart of an electronic map distance measurement method according to an embodiment of the present disclosure;

FIG. 4 is a schematic diagram illustrating information expansion during electronic map distance measurement according to an embodiment of the present disclosure;

FIG. 5 is a schematic diagram illustrating information expansion after a recommended mode is selected during electronic map distance measurement according to an embodiment of the present disclosure;

FIG. 6 is a schematic diagram illustrating information expansion after a stay point is changed during electronic map distance measurement according to an embodiment of the present disclosure;

FIG. 7 is a schematic diagram illustrating a flowchart of an exemplary electronic map distance measurement method according to an embodiment of the present disclosure;

FIG. 8 is a schematic diagram illustrating a structure of an electronic map distance measurement device according to an embodiment of the present disclosure; and

FIG. 9 is a schematic diagram illustrating another structure of the electronic map distance measurement device according to an embodiment of the present disclosure.

### DETAILED DESCRIPTION

In order to better clarify the purpose, technical solutions and advantages of the present disclosure, modes of implementing the present disclosure is further described in detail below in combination with attached figures.

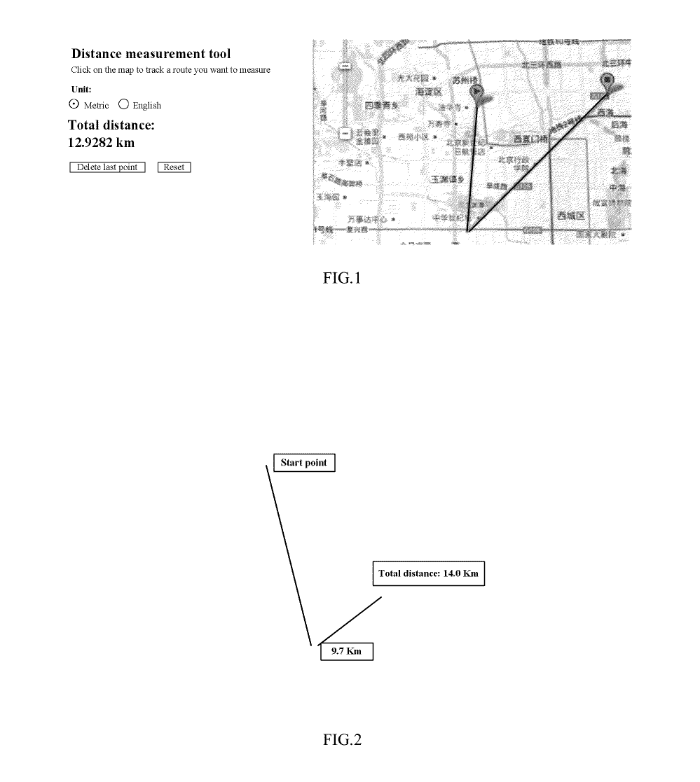

FIG. 1 is a first schematic diagram illustrating electronic map distance measurement in the traditional art. As shown in FIG. 1, on the electronic map, during a distance measurement process, only a direct distance between two points selected by a user on the electronic map is shown, and what is measured is actually a flying distance between the two points, but not a distance of a route passed via an actual road network. In addition, on the electronic map shown in FIG. 1, the user is unable to modify a stay point directly, but needs to use a button such as a “delete last point” button to backspace, and then selects a stay point on the electronic map.

FIG. 2 is a second schematic diagram illustrating electronic map distance measurement in the traditional art. Similarly, as shown in FIG. 2, on the electronic map, during a distance measurement process, only straight distances between points selected by a user on the electronic map are provided, and similarly, what is measured is actually flying distances between those points, but not distances of routes passed via an actual road network. In addition, on the electronic map shown in FIG. 2, similarly, the user is unable to modify a stay point directly, but needs to use a cross button to delete the stay point, and then selects a stay point afresh on the electronic map.

It can be seen that, in the traditional art, an actual movement route between distance measurement points may not be provided. Further, in the traditional art, a user may not directly modify a stay point between a start point and an end point, which may be inconvenient for the user to use.

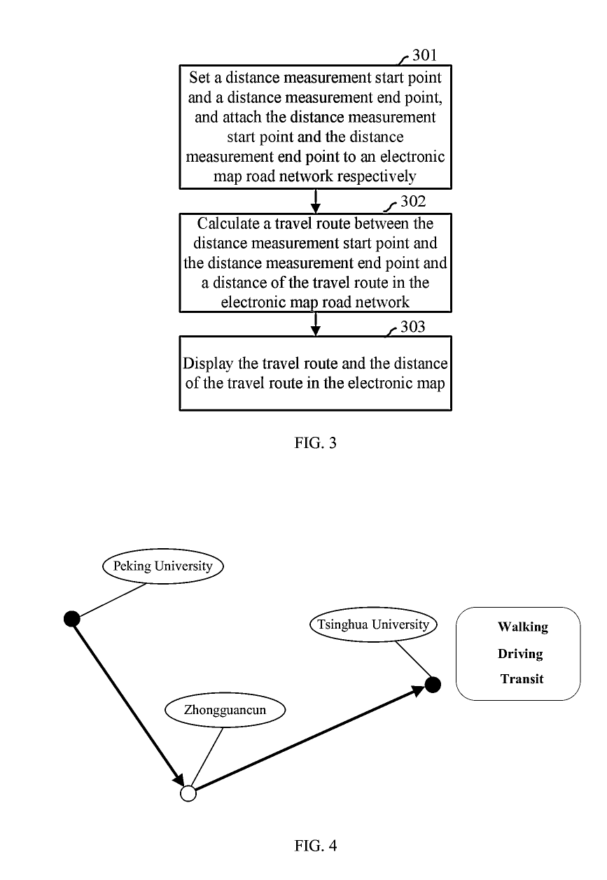

FIG. 3 is a schematic diagram illustrating a flowchart of an electronic map distance measurement method according to an embodiment of the present disclosure.

As shown in FIG. 3, the method includes the following process.

At block 301, a distance measurement start point and a distance measurement end point are set, and the distance measurement point and the distance measurement end point are attached to an electronic map road network.

Physical coordinate data of a real road network may be informationized by various means such as a global position system (GPS) to constitute an electronic map road network. Here, the distance measurement start point and the distance measurement end point are set first, and then the distance measurement start point and the distance measurement end point are selected by directly clicking on the electronic map. The distance measurement start point and the distance measurement end point may be set by inputting their geographical location names.

The electronic map road network includes geographical coordinate data information of a real road network, called electronic map road network data. In the electronic map road network data, a coordinate sequence of each road section and a connection relation between different road sections are described. After the distance measurement start point and the distance measurement end point are set, the distance measurement start point and the distance measurement end point need to be attached to the electronic map road network respectively, that is, establishing a corresponding relation between the distance measurement start point and the distance measurement end point and specific geographical coordinate data in the electronic map road network. A specific attachment process may include: determining coordinate data of display locations of the distance measurement start point and the distance measurement end point on the electronic map; and determining geographical coordinate data of the distance measurement start point and the distance measurement end point in the electronic map road network respectively, based on the coordinate data of the display locations of the distance measurement start point and the distance measurement end point on the electronic map.

After the distance measurement start point and the distance measurement end point are attached to the electronic map road network, the specific geographical coordinate data of the distance measurement start point and the distance measurement end point may be used to calculate a travel route between the distance measurement start point and the distance measurement end point and a distance of the travel route in the subsequent blocks.

At block 302, a travel route between the distance measurement start point and the distance measurement end point and a distance of the travel route are calculated in the electronic map road network.

Here, based on the coordinates of the distance measurement start point and the distance measurement end point, the travel route between the distance measurement start point and the distance measurement end point and the distance of the travel route are calculated according to a distance measurement algorithm.

There are a lot of algorithms to calculate a route and a distance between two points on an electronic map, and typically a “shortest path algorithm” is used to calculate a route. Presently, common shortest path algorithms include: Dijkstra's algorithm, A-Start (A*) algorithm, shortest path faster algorithm, Bellman-Ford algorithm, Floyd-Warshall algorithm, etc.

Specifically, in the embodiment of the present disclosure, the Dijkstra's algorithm may be used. The Dijkstra's algorithm is a typical shortest path algorithm, used to calculate a shortest path from a node to another node, and its main characteristic is expanding outward from a start point until an end point is reached. By using the Dijkstra's algorithm, a best shortest path can be obtained.

Though some path algorithms are listed in the foregoing, those people of skills are to be aware that the listed path algorithms are for illustration only and should not be construed as limitations to the protecting scope of the present disclosure.

In some circumstances, the user may need to stay in the midway of his travel. Thus, at block 301, a stay point may be further set, and the stay point is attached to the electronic map road network, that is, establishing a corresponding relation between the stay point and a specific geographical coordinate data in the electronic map road network. In this case, the block 302 may specifically include: calculating a travel route between the distance measurement start point and the stay point, and calculate a travel route between the stay point and the distance measurement end point.

If the user needs to modify the stay point, he may update the stay point by way of dragging it on the travel route of the electronic map, and attaches the updated stay point to the electronic map road network. In this case, the block 302 may specifically include: displaying a travel route from the distance measurement start point via the updated stay point to the distance measurement end point and a distance of the travel route. In an example, there may be a plurality of stay points, and in this case, travel routes and distances may be calculated according to a sequence of setting the stay points by the user. Specifically, the foregoing “shortest path algorithms” may be used to calculate the travel routes and the distances between the stay points.

Similar to the method of modifying the stay point, the user may modify the distance measurement start point and/or distance measurement end point by directly dragging it (them) on his travel route of the electronic map. Specifically, after the distance measurement start point and/or the distance measurement end point are modified on the travel route of the electronic map, the updated distance measurement start point and/or distance measurement end point need to be attached to the electronic map road network, and an updated travel route and a distance are calculated by using a distance measurement algorithm.

Generally, road network data contained in an electronic map includes road situation information, for example, whether a road is suitable for walking, whether a road is a two-lane road, a four-lane road, a six-lane road, etc. Thus, the user may further select a travel mode at block 301. For example, the user may select a walking mode, a driving mode, a transit mode, etc. In this case, at block 302, in the electronic map road network, based on the road situation information contained in the road network data, a travel route corresponding to the travel mode between the distance measurement start point and the distance measurement end point and a distance of the travel route are calculated. For example, assuming that at block 301, the user selects the walking mode, then a travel route suitable for walking between the distance measurement start point and the distance measurement end point and a distance of the travel route are calculated at block 302.

At block 303, the travel route and the distance of the travel route are displayed on the electronic map.

After the travel route between the distance measurement start point and the distance measurement end point and the distance of the travel route are calculated, the travel route and the distance of the travel route may be displayed on the electronic map in various ways. For example, the travel route may be displayed in a highlighted way, or the distance of the travel route may be displayed in a prompt box.

For example, FIG. 4 is a schematic diagram illustrating information expansion during electronic map distance measurement according to an embodiment of the present disclosure.

In FIG. 4, the distance measurement start point set by the user is “Peking University”, the distance measurement end point is “Tsinghua University”, and the stay point is “Zhongguancun”. A prompt box may be used to prompt the user to select an expected travel mode. Specific travel modes may include: walking, driving, or transit.

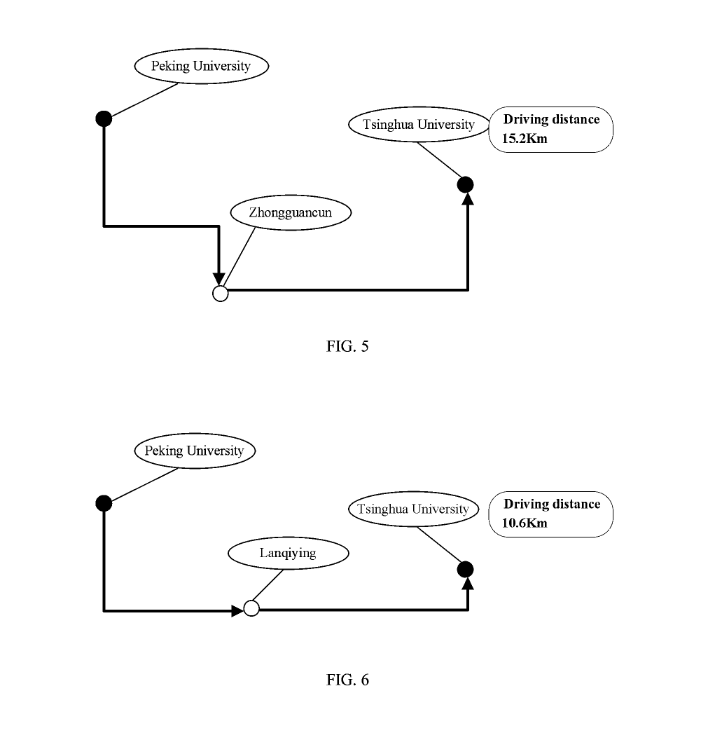

FIG. 5 is a schematic diagram illustrating information expansion after a recommended mode is selected during electronic map distance measurement according to an embodiment of the present disclosure.

In FIG. 5, the distance measurement start point set by the user is “Peking University”, the distance measurement end point is “Tsinghua University”, the stay point is “Zhongguancun”, and the travel mode selected by the user is “driving”. In this case, a driving route from “Peking University” to “Zhongguancun” and then from “Zhongguancun” to “Peking University” is highlighted, and a calculated specific distance which is 15.2 km is shown in a prompt box.

Then, the user further modifies the stay point from “Zhongguancun” to “Lanqiying” by dragging the stay point on his travel route of the electronic map.

FIG. 6 is a schematic diagram illustrating information expansion after the stay point is changed during electronic map distance measurement according to an embodiment of the present disclosure.

In FIG. 6, the distance measurement start point set by the user is “Peking University”, the end point of the distance measurement is “Tsinghua University”, the stay point is modified from “Zhongguancun” to “Lanqiying”, and the user selects the driving mode. In this case, a driving route from “Peking University” to “Lanqiying” and then from “Lanqiying” to “Tsinghua University” is displayed in highlighted way, and an updated calculated specific distance which is 10.6 km is shown in a prompt box.

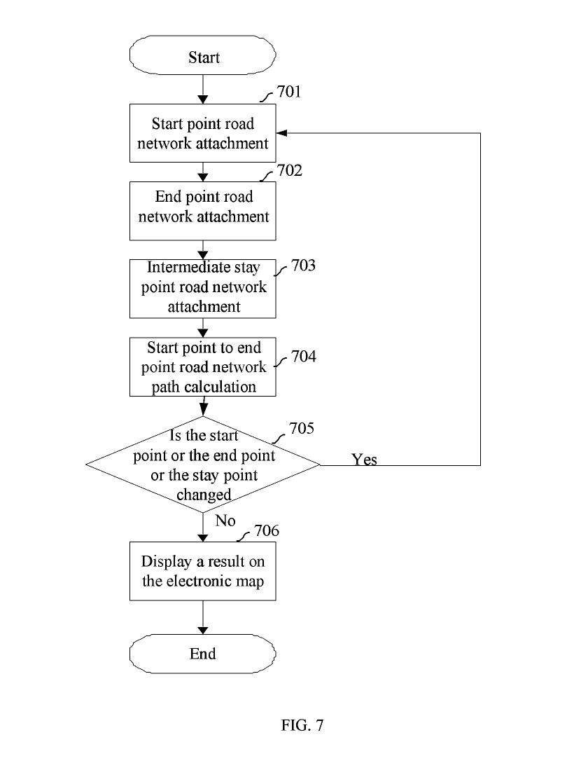

FIG. 7 is a schematic diagram illustrating a flowchart of an exemplary electronic map distance measurement method according to an embodiment of the present disclosure.

As shown in FIG. 7, the method includes the following process.

At block 701, a user sets a distance measurement start point, and attaches the distance measurement start point to an electronic map road network.

At block 702, the user sets a distance measurement end point, and attaches the distance measurement end point to the electronic map road network.

At block 703, the user sets a stay point, and attaches the stay point to the electronic map road network.

At block 704, on the electronic map road network, a travel route and a distance from the distance measurement start point to the stay point are calculated, and a travel route and a distance from the stay point to the distance measurement end point are calculated

At block 705, it is determined whether the distance measurement start point, the distance measurement end point, or the stay point on the electronic map is changed. If yes, then block 701 is returned and executed, or otherwise, block 706 is executed.

At block 706, a travel route from the distance measurement start point via the stay point to the distance measurement end point is displayed on the electronic map, and a distance of the travel route is prompted to the user.

Based on the forgoing method, the present disclosure further provides an electronic map distance measurement device.

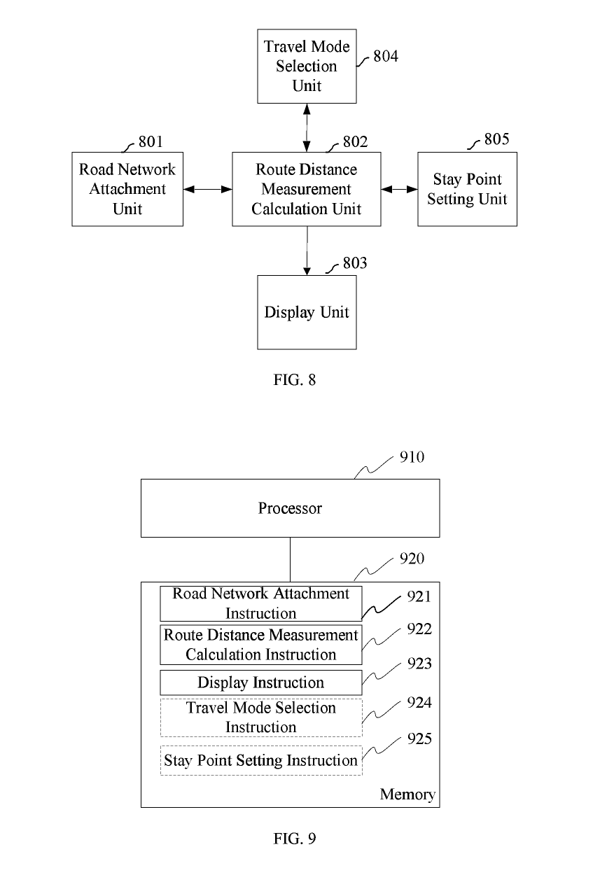

FIG. 8 is a schematic diagram illustrating a structure of an electronic map distance measurement device according to an embodiment of the present disclosure.

As shown in FIG. 8, the device includes a road network attachment unit 801, a route distance measurement calculation unit 802, and a display unit 803.

The road network attachment unit 801 is configured to set a distance measurement start point and a distance measurement end point, and attach the distance measurement start point and the distance measurement end point to an electronic map road network respectively.

The route distance measurement calculation unit 802 is configured calculate a travel route between the distance measurement start point and the distance measurement end point and a distance of the travel route in the electronic map road network.

The display unit 803 is configured to display the travel route and the distance of the travel route on the electronic map.

In an embodiment, the road network attachment unit 801 is configured to determine coordinate data of display locations of the distance measurement start point and the distance measurement end point on the electronic map, and determine geographical coordinate data of the distance measurement start point and the distance measurement end point in the electronic map road network respectively, based on the coordinate data of the display locations of the distance measurement start point and the distance measurement end point on the electronic map.

Generally, road network data contained in an electronic map includes road situation information, for example, whether a road is suitable for walking, whether a road is a two-lane road, a four-lane road, a six-lane road, etc. Thus, the user may select a walking mode, a driving mode, a transit mode, etc.

In an embodiment, the device further includes a travel mode selection unit 804. The travel mode selection unit 804 is configured to select a travel mode. The route distance measurement calculation unit 802 is configured to calculate a travel route corresponding to the travel mode between the distance measurement start point and the distance measurement end point and a distance of the travel route in the electronic map road network.

In some circumstances, since the user may need to stay during the travel, thus at block 101, a stay point is further set and the stay point is attached to the electronic map road network.

In detail, in an embodiment, the device further includes a stay point setting unit 805. The stay point setting unit 805 is configured to set a stay point and attach the stay point to the electronic map road network. In this case, the route distance measurement unit 802 is configured to calculate a travel route from the distance measurement start point to the stay point, and calculate a travel route from the stay point to the distance measurement end point on the electronic map road network. In an example, there may be a plurality of stay points, and in this case, travel routes are calculated according to a sequence of setting the stay points by the user.

It can be understood by those of skills in the art that the modules in the device according to the forgoing embodiments may be distributed in the device of the embodiments, or may be located in one or more devices different from that in the present embodiments. The modules in the foregoing embodiments may be combined into one module or may be further separated into multiple sub-modules.

In fact, the electronic map distance measurement device provided according to the present disclosure may be implemented in various ways. For example, the electronic map distance measurement device may be written into a plug-in program installed on electronic map software according to application interfaces in conformity with a certain specification, or may be encapsulated into an application for users to download and use. When it is written into a plug-in program, it may be implemented as various types of plug-ins such as ocx, dll, cab, etc. Or the electronic map distance measurement device provided according to the embodiment of the present disclosure may be implemented by specific plug-ins such as Flash plug-ins, RealPlayer plug-ins, MMS plug-ins, MIDI Stuff plug-ins, ActiveX plug-ins, etc.

Based on the technical solution provided in foregoing respective embodiments, a machine readable storage medium is provide herein, used to store instructions which cause a machine to execute the electronic map distance measurement method provided according to the present disclosure. Specifically, a system or an apparatus configured with the storage medium may be provided, and on the storage medium, software program codes which are used to carry out functions in any of the foregoing embodiments are stored, and a computer (or a CPU or MPU) of the system or apparatus reads out and executes the program codes stored on the storage medium.

In this case, the program codes per se read from the storage medium may realize the function in any of the foregoing embodiments, and thus the program codes and the storage medium on which the program codes are stored constitute a part of the mapping management technical solution.

The storage medium which provides the program codes in the embodiment may be a floppy disk, a hard disk, a magnetic disk, a magneto-optical disk, an optical disk (e.g., a CD-ROM, a CD-R, a CD-RW, a DVD-ROM, a DVD-RAM, a DVD-RW, or a DVD+RW), a magnetic tape, a non-volatile storage card, or a ROM. As an option, the program codes may be downloaded from a server computer through a communication network.

It is to be aware that not only by executing program codes read out by a computer, but also by executing program code-based instruction, an operating system on the computer is enabled to carry out a part of or all of the actual operations so as to realize the function in any of the foregoing embodiments.

For example, FIG. 9 is a schematic diagram illustrating another structure of the electronic map distance measurement device according to an embodiment of the present disclosure. As shown in FIG. 9, the device may include a memory 920, a processor 910 which communicates with the memory 920. On the memory 920, a road network attachment instruction 921, a route distance measurement calculation instruction 922, and a display instruction 923 executable by the processor 910 are stored.

The road network attachment instruction 921 is configured to instruct setting a distance measurement start point and a distance measurement end point, and attaching the distance measurement start point and the distance measurement end point to an electronic map road network.

The route distance measurement calculation instruction 922 is configured to instruct calculating a travel route between the distance measurement start point and the distance measurement end point and a distance of the travel route in the electronic map road network.

The display instruction 923 is configured to instruct displaying the travel route and the distance of the travel route on the electronic map.

Further, on the memory, a travel mode selection instruction 924 executable by the processor 910 may be further stored to instruct selecting a travel mode. Accordingly, the route distance measurement calculation instruction 922 is configured to instruct calculating a travel route corresponding to the selected travel mode between the distance measurement start point and the distance measurement end point and a distance of the travel route in the electronic map road network.

In an embodiment, the travel mode selection instruction 924 may be configured to instruct selecting the travel mode from a walking mode, a driving mode, and a transit mode.

In an embodiment, on the memory, a stay point setting instruction 925 executable by the processor 910 may be further stored, configured to instruct setting a stay point, and attaching the stay point to the electronic map road network. Accordingly, the route distance measurement calculation instruction 922 is further configured to instruct calculating a travel route from the distance measurement start point to the stay point and calculating a travel route from the stay point to the distance measurement end point in the electronic map road network.

In an embodiment, the stay point setting instruction 925 may be further configured to instruct updating the stay point on the electronic map, and attach the updated stay point to the electronic map road network. Accordingly, the route distance measurement calculation instruction 922 may further be configured to instruct calculating a travel route from the distance measurement start point to the updated stay point and calculating a travel route from the updated stay point to the distance measurement end point in the electronic map road network. The display instruction 923 is further configured to instruct displaying a travel route from the distance measurement start point via the updated stay point to the distance measurement end point and a distance of the travel route on the electronic map.

In an embodiment, the stay point setting instruction 925 may be configured to instruct updating the stay point by dragging it on a travel route on the electronic map.

In an embodiment, the road network attachment instruction 921 may be configured to instruct determining coordinate data of display locations of the distance measurement start point and the distance measurement end point on the electronic map, and determining geographical coordinate data of the distance measurement start point and the distance measurement end point in the electronic map road network respectively, based on the coordinate data of the display locations of the distance measurement start point and the distance measurement end point.

As described in the foregoing, in the embodiments of the present disclosure, first the distance measurement start point and the distance measurement end point are set, and the distance measurement start point and the distance measurement end point are attached to the electronic map road network; and then a travel route between the distance measurement start point and the distance measurement end point and a distance of the travel route are calculated in the electronic map road network, and then the travel route and the distance of the travel route are displayed on the electronic map. As is seen, when the methods of the present disclosure are applied, by directly attaching to the electronic map to measure, an actual travel route and a distance are provided so as to improve accuracy of route inquiry by a user.

Further, in the embodiments of the present disclosure, a stay point on the travel route of the electronic map may be dragged directly, which is convenient for the user to use.

In addition, the embodiments of the present disclosure may provide various options of the travel mode, and the information may be prompted in various ways.

The above are only better embodiments of the present invention, and should not be construed as limitations to the present disclosure. Any modification, equivalent replacement, improvement and the like within the spirit and principle of the present invention should be contained in a protection scope of the implementation.

1. An electronic map distance measurement method, comprising:
setting a distance measurement start point and a distance measurement end point, and attaching the distance measurement start point and the distance measurement end point to an electronic map road network respectively;
calculating a travel route between the distance measurement start point and the distance measurement end point and a distance of the travel route in the electronic map road network; and
displaying the travel route and the distance of the travel route on the electronic map.

2. The electronic map distance measurement method of claim 1, wherein the method further comprises: selecting a travel mode; and
calculating the travel route between the distance measurement start point and the distance measurement end point and the distance of the travel route in the electronic map road network comprises:
calculating a travel route corresponding to the travel mode between the distance measurement start point and the distance measurement end point and a distance of the travel route in the electronic map road network.

3. The electronic map distance measurement method of claim 2, wherein the travel mode comprises:
a walking mode;
a driving mode; or
a transit mode.

4. The electronic map distance measurement method of claim 1, wherein the method further comprises: setting a stay point, and attaching the stay point to the electronic map road network; and
calculating the travel route between the distance measurement start point and the distance measurement end point and the distance of the travel route in the electronic map road network comprises:
calculating a travel route from the distance measurement start point to the stay point, and calculating a travel route from the stay point to the distance measurement end point in the electronic map road network.

5. The electronic map distance measurement method of claim 4, wherein the method further comprises: updating the stay point on the electronic map; and the method further comprises:
attaching the updated stay point to the electronic map road network;
calculating a travel route from the distance measurement start point to the updated stay point and calculating a travel route from the updated stay point to the distance measurement end point in the electronic map road network; and
displaying a travel route from the distance measurement start point via the updated stay point to the distance measurement end point and a distance of the travel route on the electronic map.

6. The electronic map distance measurement method of claim 5, wherein updating the stay point on the electronic map comprises: updating the stay point by dragging the stay point on a travel route on the electronic map.

7. The electronic map distance measurement method of claim 1, wherein attaching the distance measurement start point and the distance measurement end point to the electronic map road network respectively comprises:
determining coordinate data of display locations of the distance measurement start point and the distance measurement end point on the electronic map; and
determining geographical coordinate data of the distance measurement start point and the distance measurement end point in the electronic map road network respectively, based on the coordinate data of the display locations of the distance measurement start point and the distance measurement end point on the electronic map.

8. (canceled)

9. (canceled)

10. (canceled)

11. (canceled)

12. (canceled)

13. (canceled)

14. (canceled)

15. An electronic map distance measurement device, comprising a memory and a processor which communicates with the processor, wherein on the memory a road network attachment instruction, a route distance measurement calculation instruction, and a display instruction executable by the processor are stored, and wherein
the road network attachment instruction is configured to instruct setting a distance measurement start point and a distance measurement end point, and attaching the distance measurement start point and the distance measurement end point to an electronic map road network respectively;
the route distance measurement calculation instruction is configured to instruct calculating a travel route between the distance measurement start point and the distance measurement end point and a distance of the travel route in the electronic map road network; and
the display instruction is configured to instruct displaying the travel route and the distance of the travel route on the electronic map.

16. The electronic map distance measurement device of claim 15, wherein on the memory is further stored:
a travel mode selection instruction configured to instruct selecting a travel mode; and
the route distance measurement calculation instruction is configured to calculate a travel route corresponding to the travel mode selected by the travel mode selection instruction between the distance measurement start point and the distance measurement end point and a distance of the travel route.

17. The electronic map distance measurement device of claim 16, wherein
the travel mode selection instruction is configured to instruct selecting the travel mode from a walking mode, a driving mode, and a transit mode.

18. The electronic map distance measurement device of claim 15, wherein on the memory is further stored:
a stay point setting instruction executable by the processor and configured to instruct setting a stay point and attaching the stay point to the electronic map road network; and
the route distance measurement calculation instruction is further configured to instruct calculating a travel route from the distance measurement start point to the stay point and calculating a travel route from the stay point to the distance measurement end point in the electronic map road network.

19. The electronic map distance measurement device of claim 18, wherein
the stay point setting instruction is further configured to instruct updating the stay point on the electronic map and attaching the updated stay point to the electronic map road network;
the route distance measurement calculation instruction is further configured to instruct calculating a travel route from the distance measurement start point to the updated stay point and calculating a travel route from the updated stay point to the distance measurement end point in the electronic map road network; and
the display instruction is further configured to instruct displaying a travel route from the distance measurement start point via the updated stay point to the distance measurement end point and a distance of the travel route on the electronic map.

20. The electronic map distance measurement device of claim 19, wherein
the stay point setting instruction is configured to instruct updating the stay point by dragging the stay point on a travel route on the electronic map.

21. The electronic map distance measurement device of claim 15, wherein
the road network attachment instruction is configured to instruct determining coordinate data of display locations of the distance measurement start point and the distance measurement end point on the electronic map, and determining geographical coordinate data of the distance measurement start point and the distance measurement end point in the electronic map road network respectively, based on the coordinate data of the display locations of the distance measurement start point and the distance measurement end point on the electronic map.

22. A computer readable storage medium on which a computer program is stored, the computer program configured to:
set a distance measurement start point and a distance measurement end point, and attach the distance measurement start point and the distance measurement end point to an electronic map road network respectively;
calculate a travel route between the distance measurement start point and the distance measurement end point and a distance of the travel route in the electronic map road network; and
display the travel route and the distance of the travel route on the electronic map.

23. The computer readable storage medium of claim 22, wherein the computer program is further configured to:
calculate a travel route corresponding to the travel mode between the distance measurement start point and the distance measurement end point and a distance of the travel route in the electronic map road network.

24. The computer readable storage medium of claim 23, wherein the travel mode comprises:
a walking mode;
a driving mode; or
a transit mode.

25. The computer readable storage medium of claim 22, wherein the computer program is further configured to:
set a stay point, and attach the stay point to the electronic map road network; and
calculate a travel route from the distance measurement start point to the stay point, and calculate a travel route from the stay point to the distance measurement end point in the electronic map road network.

26. The computer readable storage medium of claim 25, wherein the computer program is further configured to:
update the stay point on the electronic map;
attach the updated stay point to the electronic map road network;
calculate a travel route from the distance measurement start point to the updated stay point and calculate a travel route from the updated stay point to the distance measurement end point in the electronic map road network; and
display a travel route from the distance measurement start point via the updated stay point to the distance measurement end point and a distance of the travel route on the electronic map.

27. The computer readable storage medium of claim 25, wherein the computer program is further configured to:
update the stay point by dragging the stay point on the travel route on the electronic map.
